(19) United States
(12) Patent Application Publication
(10) Pub. No.: US 2011/0155765 A1
(43) Pub. Date: Jun. 30, 2011

(54) HANDY SAN SYSTEMS

(76) Inventor: Vincent Properzi, Slave Lake (CA)

(21) Appl. No.: 12/975,849

(22) Filed: Dec. 22, 2010

Related U.S. Application Data
(60) Provisional application No. 61/290,943, filed on Dec. 30, 2009.

(51) Int. Cl. B67D 7/00; B67D 7/84; B67D 7/60; B67D 7/76

(52) U.S. Cl. 222/175; 222/401

(57) ABSTRACT

Handy San is a hand sanitizer dispenser that can be worn around the wrist like a bracelet. This item allows individuals user-convenience to guard against bacteria and germs to keep their hands clean to promote personal hygiene. The comfortable bracelet dispenser allows for freedom of movement and easy access to hand sanitizer liquid. The device is comprised of a hollow wristband made of plastic or other suitable biodegradable compounds. There is an opening on one side of the bracelet where the sanitizer can be dispensed, with a cap that hinges open and closed. Users open the cap and then slide the dispenser lever with one hand allowing the device to be activated. On the other side of the bracelet may be a small air pump button that can be pressed to increase internal pressure enabling the liquid to flow out of the device easier. The device is refillable and/or disposable.

### CROSS-REFERENCE TO RELATED APPLICATION

The present application is related to and claims priority from prior provisional application Ser. No. 61/290,943, filed Dec. 30, 2009 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### FIELD OF THE INVENTION

The present invention relates generally to the field of dispensers and more specifically relates to a wrist-mounted hand sanitizer dispenser, the Handy San.

### DESCRIPTION OF THE RELATED ART

The Centers for Disease Control recommends frequently washing of hands with soap and water and/or use of a hand sanitizer as an effective way to prevent the transmission of dangerous diseases. If soap and water are not available, which is often the case, it is recommended to use a hand sanitizer that contains at least 60 percent alcohol. The alcohol content kills many different kinds of bacteria, including antibiotic resistant bacteria and TB bacteria. It also has high viricidal activity against many different kinds of viruses, including enveloped viruses such as the flu virus, the common cold virus, and HIV. Various authorities on disease believe that alcohol rubs are approximately 100 times more effective against viruses than any form of hand washing. When performing tasks that contain higher than usual risk, sanitizing the hands with increased frequency is advocated for effective disease control. Unfortunately many hand sanitizing dispensers are wall-mounted and may not be portable and thus are inconvenient to use.

As a solution, many consumers prefer to carry a small bottle of hand sanitizer with them in their purse, pocket or briefcase; however often times these items are not carried on the person, once again leaving the individual without easy access to sanitizing means. This may create unhealthy conditions especially for parents of young children, the elderly, or those with weak immune systems. A device is needed that provides convenient access to a personal supply of hand sanitizer in virtually all circumstances.

Various attempts have been made to solve the above-mentioned problems such as those found in U.S. Pat. Nos. 7,316,332; 5,217,143; 4,736,876; 2008/0067193; 4,972,684; and 2004/0138631. This prior art is representative of hand sanitizer dispensers. None of the above inventions and patents, taken either singly or in combination, is seen to describe the invention as claimed.

Ideally, a hand sanitizer dispenser should be user-friendly, be conveniently located for use and, yet would operate reliably and be manufactured at a modest expense. Thus, a need exists for a reliable Handy San system to provide an aesthetically-pleasing wrist-mountable hand sanitizer dispenser and to avoid the above-mentioned problems.

### BRIEF SUMMARY OF THE INVENTION

In view of the foregoing disadvantages inherent in the known hand sanitizer dispenser art, the present invention provides a novel Handy San system. The general purpose of the present invention, which will be described subsequently in greater detail is to provide a convenient-to-use wrist-mountable hand sanitizer dispenser.

A wrist-mountable hand sanitizer dispenser system is disclosed herein comprising: a wrist-mountable hand sanitizer dispenser having, a hollow plastic bracelet band wearable about a circumference of a user's wrist having an interior volume for storing at least one gel, foam or liquid hand sanitizing solution. The device further comprises a container having a cap with a hinging mechanism; a hinging member with a pin wherein the hollow plastic bracelet band is openable via the hinging member rotatable about the pin's conterline axis; and an air pump with a depressible button that when depressed increases internal pressure on the hand sanitizing solution to promote ease of dispensing the hand sanitizing solution out of a dispenser aperture(s). Additionally, a one-handed operable slidable dispenser lever may be located under the cap. The wrist-mountable hand sanitizer dispenser is refillable and biodegradably disposable. The hand sanitizer may be sealably contained in the container by the cap. The pump is user-activatable to dispense a pre-determined volume of hand sanitizer onto the hand(s) of a user to promote at least one cleaning-sanitizing action.

A kit is also discussed in the present disclosure including a wrist-mountable hand sanitizer dispenser, at least one gel, foam or liquid hand sanitizing solution. The wrist-mountable hand sanitizer dispenser may also have at least one indicia promotional design.

A method of use for a wrist-mountable hand sanitizer dispenser is also disclosed herein comprising the steps of: filling the wrist-mountable hand sanitizer dispenser with a foam, gel or liquid hand sanitizer solution; circumferentially-mounting the wrist-mountable hand sanitizer dispenser about a wrist of a user; dispensing the foam, gel or liquid hand sanitizer solution onto at least one hand of a user to provide at least one sanitizing-cleaning action. The method may further comprise the step(s) of refilling the wrist-mountable hand sanitizer dispenser with a foam, gel or liquid hand sanitizer solution for a future sanitizing-cleaning action or the device may be biodegradably disposed of.

The present invention holds significant improvements and serves as a Handy San, wrist-mountable hand sanitizer dispenser system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Handy San, constructed and operative according to the teachings of the present invention.

FIG. 1 shows a perspective view illustrating a wrist-mountable hand sanitizer dispenser according to an embodiment of the present invention.

FIG. 2 is another perspective view illustrating the wrist-mountable hand sanitizer dispenser according to an embodiment of the present invention of FIG. 1.

FIG. 3 is yet another perspective view illustrating the wrist-mountable hand sanitizer dispenser according to an embodiment of the present invention of FIG. 1.

FIG. 4 is a perspective view illustrating the wrist-mountable hand sanitizer dispenser in an as-worn condition according to an embodiment of the present invention of FIG. 1.

FIG. 5 is a perspective view illustrating the wrist-mountable hand sanitizer dispenser in an in-use condition according to an embodiment of the present invention of FIG. 1.

FIG. 6 is a flowchart illustrating a method of use for the wrist-mountable hand sanitizer dispenser according to an embodiment of the present invention of FIGS. 1-5.

The various embodiments of the present invention will hereinafter be described in conjunction with the appended drawings, wherein like designations denote like elements.

### DETAILED DESCRIPTION

As discussed above, embodiments of the present invention relate to a hand sanitizer dispenser and more particularly to a wrist-mountable hand sanitizer dispenser as used to improve the user-convenience of hand sanitizer dispensers.

Referring generally to the present invention and system, Handy San is a hand sanitizer dispenser that can be worn around the wrist like a bracelet. This novel device allows individuals of virtually any age that have concerns about bacteria and germs to keep their hands clean whenever they feel their personal hygiene has been compromised. The comfortable bracelet dispenser allows for freedom of movement and easy, convenient access to hand sanitizer liquid. The design can be tailored to promote popular sports teams, universities, businesses or other such establishments.

Handy San comprises a personal dispenser for hand sanitizer that can be worn comfortably around the wrist, as previously mentioned. This unique item may have a hollow wristband made of plastic or other suitable biodegradable compound(s). There may be an opening (aperture) on one side of the bracelet where the sanitizer can be dispensed from, with a cap that repeatably hinges between open and closed positions (for filling—open, for sealing—closed). Users could open the cap and then slide the dispenser lever with one hand allowing the device to be activated. On the other side of the bracelet may be a small air pump button that can be pressed to increase internal pressure by decreasing the internal volume thereby enabling the liquid to flow out of the device better. Users could then rub their hands together sanitizing the skin. This item can be produced in a manner that allows it to be refillable or disposable. The bracelet design could be available in several sizes and in an assortment of colors to suit user preferences. Companies, sports teams, schools and other establishments could display their colors, name or other insignia on the outer rim of the device, thereby creating an aesthetic promotional device.

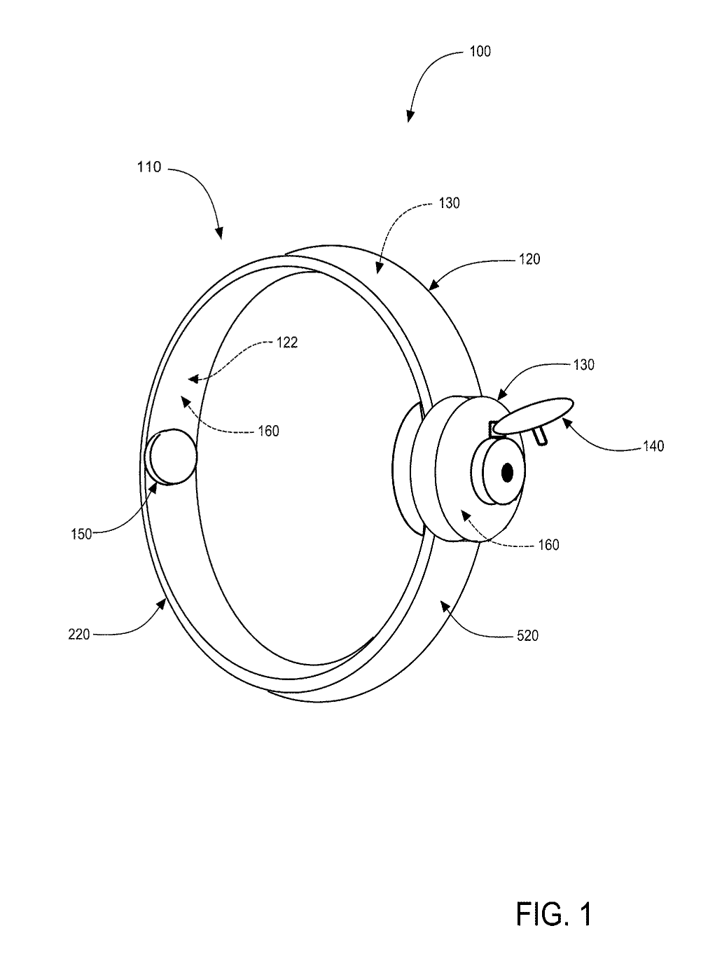

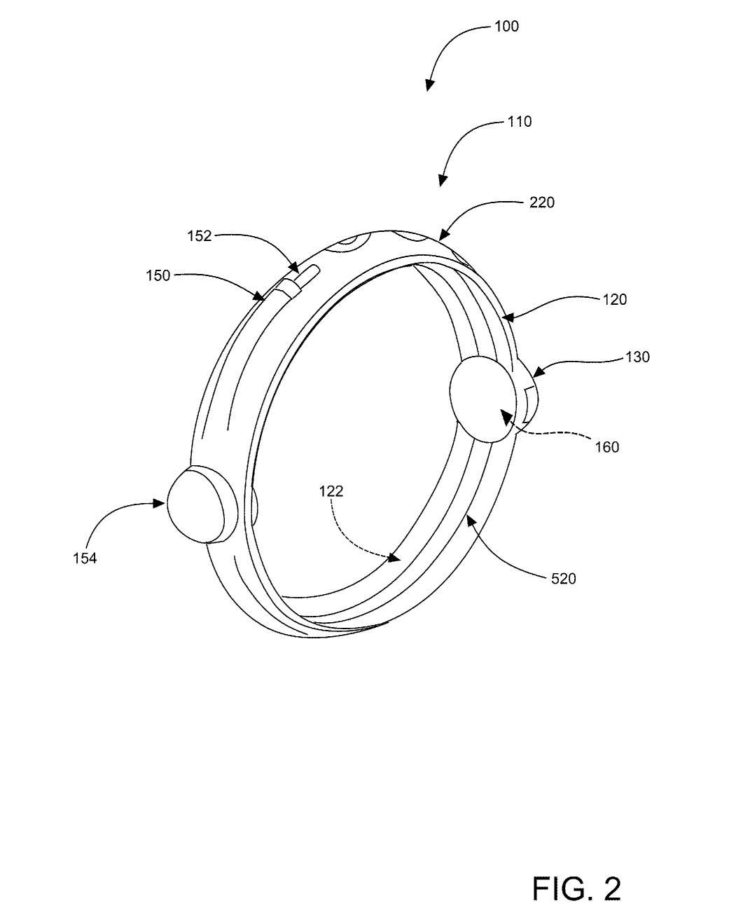

Referring now to the drawings by numerals of reference there is shown in FIGS. 1-3, wrist-mountable hand sanitizer dispenser 110 according to embodiment(s) of the present invention, Handy San. Wrist-mountable hand sanitizer dispenser system 100 of the present invention comprises wrist-mountable hand sanitizer dispenser 110. Wrist-mountable hand sanitizer dispenser 110 preferably comprises: band 120; container 130 having cap 140 preferably with a hinging mechanism; and pump 150; wherein hand sanitizer 160 is substantially sealably contained in container 130 by cap 140. Pump 150 is user-activatable to dispense a pre-determined volume of hand sanitizer 160 onto at least one hand of a user to promote at least one cleaning action (sanitizing means therefor). Wrist-mountable hand sanitizer dispenser 110 may sealably contain and store hand sanitizer 160 comprising foam, gel, and/or liquid.

In a preferred embodiment of the present invention band 120 is hollow providing an interior volume 122 for storing hand sanitizer 160. Band 120 is preferably made of plastic material so as to be cost-effective to manufacture, lightweight and substantially durable. Further, plastic does not react chemical to any substantial extent with contained hand sanitizer 160. Band 120 may comprise a bracelet 220 or other such jewelry item that is aesthetically appealing when worn. Upon reading this specification, it should be appreciated that, under appropriate circumstances, considering such issues as user preferences, design preference, structural requirements, marketing preferences, cost, available materials, technological advances, etc., other band materials such as, for example, ferrous and non-ferrous materials, composites, rubber, etc., may be sufficient equivalents.

Wrist-mountable hand sanitizer dispenser 110, as disclosed previously, preferably comprises pump 150. Pump 150 more specifically preferably comprises an air pump 152. Upon reading this specification, it should be appreciated that, under appropriate circumstances, considering such issues as user preferences, design preference, structural requirements, marketing preferences, cost, available materials, technological advances, etc., other pumping/dispensing arrangements/means such as, for example, electric, mechanical dispensers, etc., may be sufficient. Air pump 152 is preferred because of its lightweight and substantially maintenance-free qualities.

Pump 150 may comprise a depressible button 154 that when depressed increases internal pressure making it easier to dispense hand sanitizer 160. Depressible button 154, when depressed, increases internal pressure by decreasing interior volume 122. This increase in pressure overcomes ambient atmospheric pressure such that hand sanitizer 160 is easier to dispense.

Wrist-mountable hand sanitizer dispenser 110 further comprises a slidable dispenser lever located under cap 140 in certain embodiments. The slidable dispenser lever is operable using one hand, such that it is conveniently operable by the user. In certain embodiments wrist-mountable hand sanitizer dispenser 110 is refillable and or biodegradably disposable in alternate embodiments.

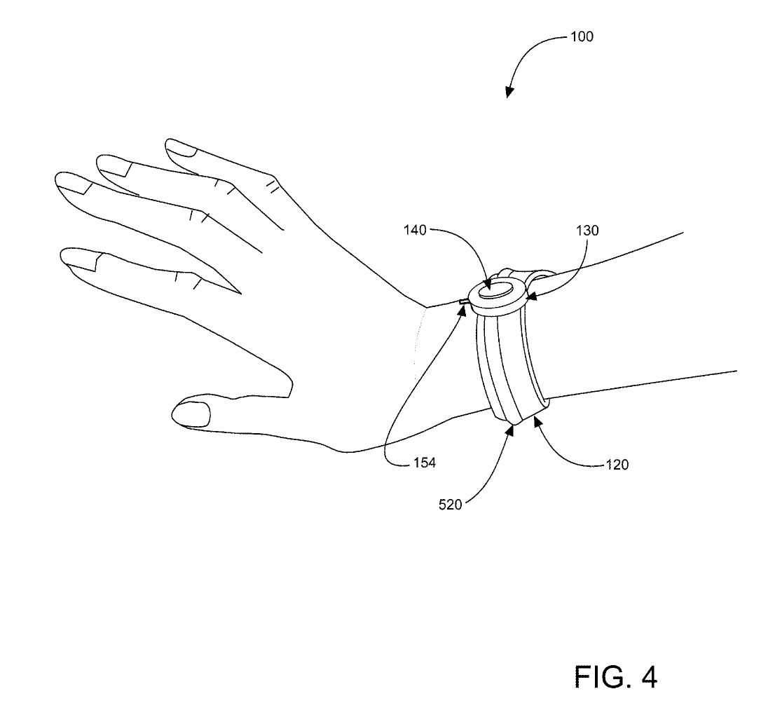

Referring now to FIG. 4, a perspective view illustrating wrist-mountable hand sanitizer dispenser 110 in an as-worn condition 400 according to an embodiment of the present invention of FIG. 1.

Band 120 preferably comprises at least one dispenser aperture wherefrom hand sanitizer 160 may be dispensed therefrom. In this way dispenser aperture is in fluid communication with the atmosphere such that when dispensed it is available to be disposed on the hand(s) of the user. Band 120 is openable via a hinging member rotatable about a pin centerline axis. In this way band 120 may be pivoted between open and closed positions to be placed about a user's wrist for at least one wearing period or removed for a refilling, discarding or for non-use period(s). This feature provides that the device is readily and easily donable and removable on a variety of user-sized wrists. In other embodiments band 120 comprises a one-piece construction and is non-openable. Companies, sports teams, schools and other establishments may display their colors, name or other insignia on the outer rim of the device, thereby creating an aesthetic promotional device for advertising or other decorative means.

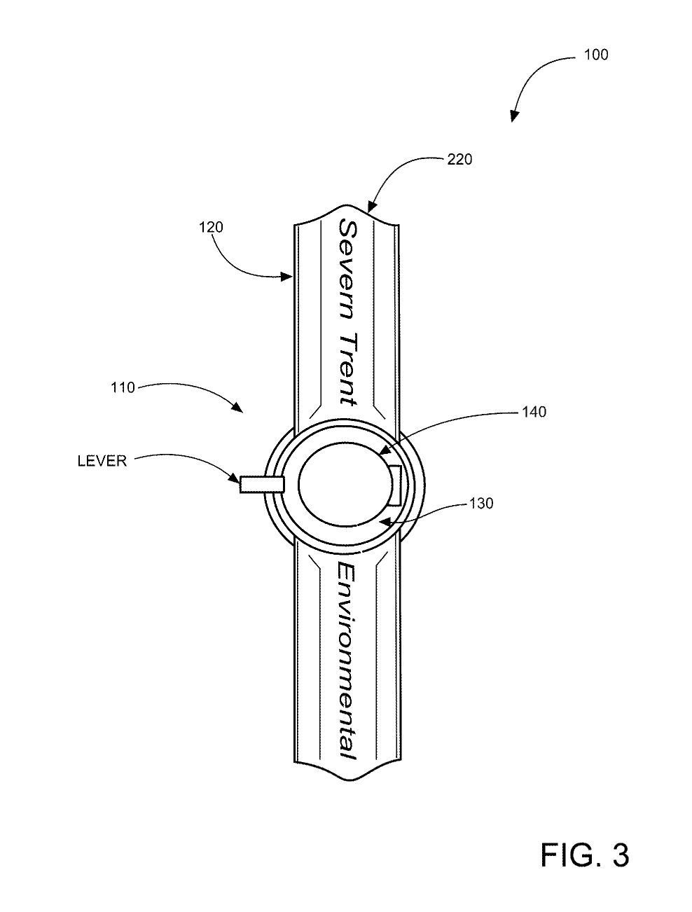

Wrist-mountable hand sanitizer dispenser system 100 may be sold as kit 440 comprising the following parts: at least one wrist-mountable hand sanitizer dispenser 110 at least one gel, foam or liquid hand sanitizing solution (hand sanitizer 160); at least one indicia promotional design (shown in FIG. 3); and optionally at least one set of user instructions (not shown). Wrist-mountable hand sanitizer dispenser system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

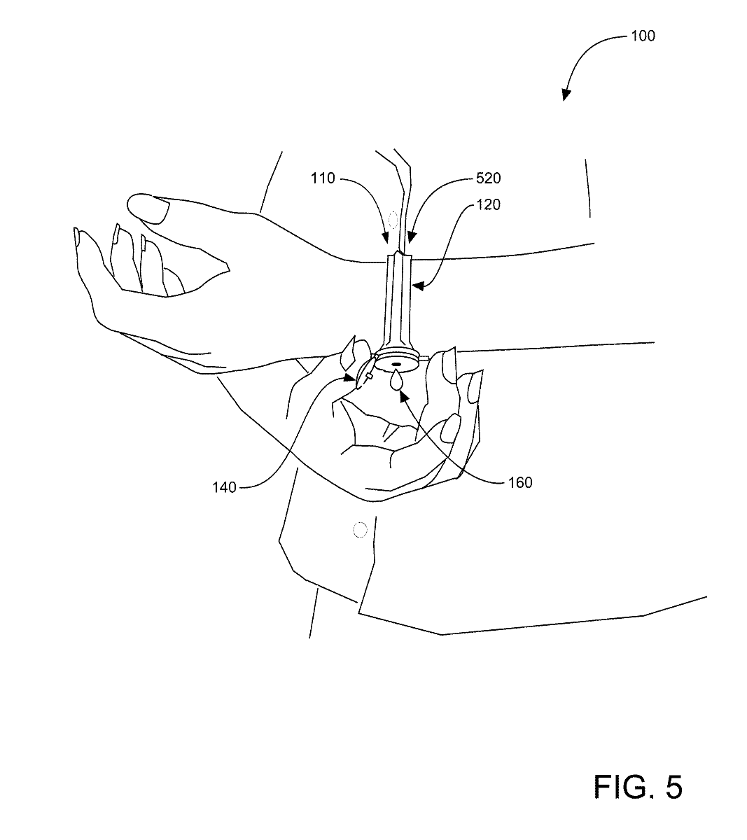

Referring now to FIG. 5, a perspective view illustrating the wrist-mountable hand sanitizer dispenser 110 in an in-use condition 500 according to an embodiment of the present invention of FIG. 1.

Wrist-mountable hand sanitizer dispenser system 100 within a preferred embodiment of the present invention (as shown) comprises: a wrist-mountable hand sanitizer dispenser 110 having a hollow plastic bracelet band 520 wearable about a circumference of a user's wrist having at least one interior volume 122 for storing (storably-containing) at least one gel, foam or liquid hand sanitizing solution (at least herein embodying hand sanitizer 160); container 130 having a sealable cap 140 with a hinging mechanism. Interior volume 122 is in fluid communication with the atmosphere via a dispensing aperture. Wrist-mountable hand sanitizer dispenser 110 further comprises a hinging member with a pin wherein hollow plastic bracelet band 520 is openable via the hinging member rotatable about a pin axis.

This particular embodiment also comprises air pump 152 with a depressible button 154 that when depressed increases internal pressure on hand sanitizing solution 160 to promote ease of dispensing hand sanitizing solution 160 out of at least one dispenser aperture. Dispenser aperture is small in diameter (constricted) such that it substantially contains hand sanitizer 160 within interior volume 122 except as when depressible button 154 is depressed. The device as shown also has a one-handed operable slidable dispenser lever located under cap 140. This wrist-mountable hand sanitizer dispenser 110 is refillable and biodegradably disposable such that it is recyclable and does not create an environmental footprint. Hand sanitizer 160 is contained in container 130 by cap 140; and wherein pump 150 is user-activatable to dispense a pre-determined volume of hand sanitizer 160 onto at least one hand of a user to promote at least one cleaning action. In these ways and others the present invention allows individuals user-convenience to guard against bacteria and germs to keep their hands clean to promote personal hygiene. A method of use 600 is disclosed below for the described invention.

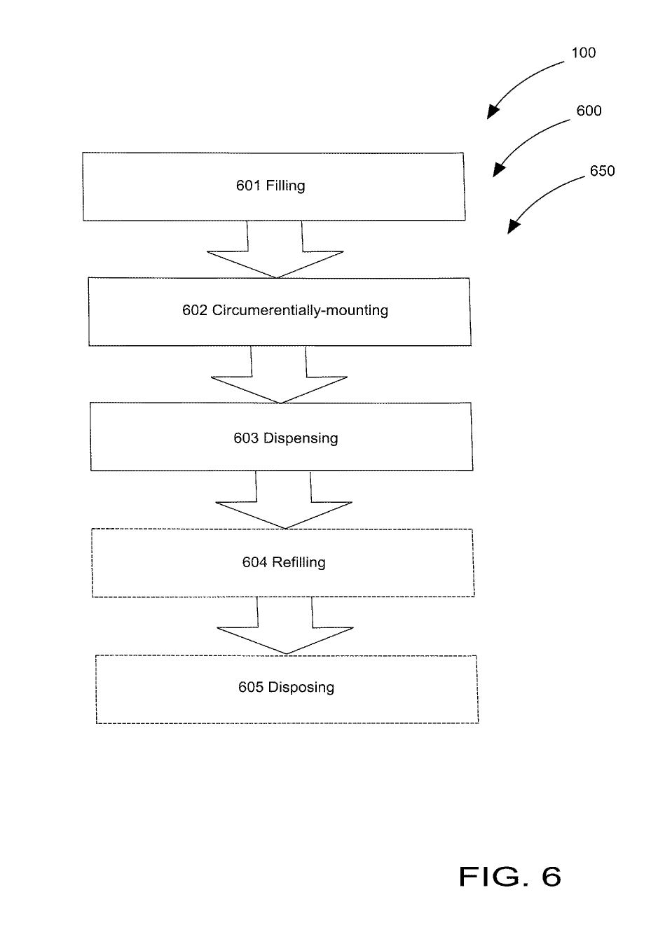

FIG. 6 is a flowchart 650 illustrating a method of use 600 for wrist-mountable hand sanitizer dispenser 110 according to an embodiment of the present invention of FIGS. 1-5.

A method of use 600 for wrist-mountable hand sanitizer dispenser 110 preferably comprises the steps of: step one 601 filling wrist-mountable hand sanitizer dispenser 110 with a foam, gel or liquid hand sanitizer solution (hand sanitizer 160); step two 602 (the user) circumferentially-mounting/donning wrist-mountable hand sanitizer dispenser 110 about a wrist of a user; and step three 603 dispensing foam, gel or liquid hand sanitizer solution (hand sanitizer 160) onto at least one hand of a user to provide at least one sanitizing-cleaning action.

Method of use 600 may further comprise the optional step four 604 of refilling wrist-mountable hand sanitizer dispenser 110 with a foam, gel or liquid hand sanitizer solution (hand sanitizer 160) for a future sanitizing-cleaning action. Optionally step five 605 may comprise environmentally disposing of wrist-mountable hand sanitizer dispenser 110.

It should be noted that steps 604 and 605 are optional steps and may not be implemented in all cases. Optional steps of method 600 are illustrated using dotted lines in FIG. 6 so as to distinguish them from the other steps of method 600.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A wrist-mountable hand sanitizer dispenser comprising:
a band;
a container having a cap with a hinging mechanism; and
a pump;
wherein hand sanitizer is storably-contained in said container by said cap; and
wherein said pump is user-activatable to dispense a pre-determined volume of said hand sanitizer onto at least one hand of a user to promote at least one cleaning action.

2. The wrist-mountable hand sanitizer dispenser of claim 1 wherein said band is hollow providing an interior volume for storing said hand sanitizer.

3. The wrist-mountable hand sanitizer dispenser of claim 1 wherein said band is plastic.

4. The wrist-mountable hand sanitizer dispenser of claim 1 wherein said pump is an air pump.

5. The wrist-mountable hand sanitizer dispenser of claim 1 wherein said pump comprises a depressible button that when depressed increases internal pressure.

6. The wrist-mountable hand sanitizer dispenser of claim 1 further comprising a slidable dispenser lever located under said cap.

7. The wrist-mountable hand sanitizer dispenser of claim 6 wherein said slidable dispenser lever is operable using one said hand.

8. The wrist-mountable hand sanitizer dispenser of claim 1 wherein said wrist-mountable hand sanitizer dispenser is refillable.

9. The wrist-mountable hand sanitizer dispenser of claim 1 wherein said wrist-mountable hand sanitizer dispenser is biodegradably disposable.

10. The wrist-mountable hand sanitizer dispenser of claim 1 wherein said band comprises a bracelet wearable about a wrist of said user.

11. The wrist-mountable hand sanitizer dispenser of claim 1 wherein said band comprises at least one dispenser aperture.

12. The wrist-mountable hand sanitizer dispenser of claim 1 wherein said band is openable via a hinging member rotatable about a pin centerline axis.

13. The wrist-mountable hand sanitizer dispenser of claim 1 wherein said band comprises a one-piece construction and is non-openable.

14. The wrist-mountable hand sanitizer dispenser of claim 2 wherein said hand sanitizer comprises foam.

15. The wrist-mountable hand sanitizer dispenser of claim 2 wherein said hand sanitizer comprises gel.

16. The wrist-mountable hand sanitizer dispenser of claim 2 wherein said hand sanitizer comprises liquid.

17. A wrist-mountable hand sanitizer dispenser system comprising:
a wrist-mountable hand sanitizer dispenser having,
a hollow plastic bracelet band wearable about a circumference of a user's wrist having an interior volume for storing at least one gel, foam or liquid hand sanitizing solution;
a container having a cap with a hinging mechanism;
a hinging member with a pin, wherein said hollow plastic bracelet band is openable via said hinging member rotatable about a pin centerline axis;
an air pump with a depressible button that when depressed increases internal pressure on said hand sanitizing solution to promote ease of dispensing said hand sanitizing solution out of a dispenser aperture; and
a one-handed operable slidable dispenser lever located under said cap;
wherein said wrist-mountable hand sanitizer dispenser is refillable and biodegradably disposable;
wherein hand sanitizer is sealably contained in said container by said cap; and
wherein said pump is user-activatable to dispense a pre-determined volume of said hand sanitizer onto at least one hand of a user to promote at least one cleaning action.

18. The wrist-mountable hand sanitizer dispenser system of claim 17 further comprising a kit having said wrist-mountable hand sanitizer dispenser, at least one gel, foam or liquid said hand sanitizing solution and wherein said wrist-mountable hand sanitizer dispenser has at least one indicia promotional design.

19. A method of use for a wrist-mountable hand sanitizer dispenser comprising the steps of:
filling said wrist-mountable hand sanitizer dispenser with a foam, gel or liquid hand sanitizer solution;
circumferentially-mounting/donning said wrist-mountable hand sanitizer dispenser about a wrist of a user; and
dispensing said foam, gel or liquid hand sanitizer solution onto at least one hand of said user to provide at least one sanitizing-cleaning action.

20. The method of claim 19 further comprising the step of refilling said wrist-mountable hand sanitizer dispenser with a foam, gel or liquid said hand sanitizer solution for a future said sanitizing-cleaning action.
